(19) United States
(12) Patent Application Publication
(10) Pub. No.: US 2001/0018707 A1
(43) Pub. Date: Aug. 30, 2001

(54) Web server system and method for controlling a web server system

(76) Inventor: Tetsuji Seta, Tokyo (JP)

Correspondence Address: Whitham, Curtis & Whitham, Reston International Center, Suite 900, 11800 Sunrise Valley Dr., Reston, VA, 20191, US

(21) Appl. No.: 09/793,516

(22) Filed: Feb. 27, 2001

(30) Foreign Application Priority Data
Feb. 29, 2000 (JP) 2000-53842

(51) Int. Cl. G06F 15/16; G06F 17/24

(52) U.S. Cl. 709/218; 707/513

(57) ABSTRACT

A web server system has a web content block having a HTML block and CGI/SSI block, a processor block and an ID control block for allocating ID numbers to the web content block and the processor block. The web content block delivers a message for a request of processing by the processor block upon receipt of the request from a browser of a client computer. The web content block receives the result of the processing from the processor block and transfer the result to the browser for display of the result.

### BACKGROUND OF THE INVENTION

(a) Field of the Invention

The present invention relates to a web server system and a method for controlling the web server system, and more particularly, to a control system for controlling the web contents of the web server system connected to a client computer through the internet.

(b) Description of the Related Art

HTML (hyper text markup language) is generally used for describing a homepage accessed by web browsers through the internet. In addition, CGI (common gateway interface) and SSI (server side interface), which provide display tools operating on the web browsers, have been used for providing specific services such as retrieval on the homepage of the internet. Those services are supplied as the programs of CGI/SSI, which are generally described in Perl- or C-languages. In this text, HTML documents, CGI and SSI (CGI/SSI) are referred collectively to as web contents.

The CGI file is disposed on the homepage in place of HTML documents. Execution of the program in the CGI file creates a HTML document, which is then displayed on the screen by the web browser. For example, the word “hello” can be displayed by the HTML document, and also can be displayed by using the executable statement in the CGI file.

The SSI specifies a processing to be called in a HTML document for instructing the web server to display the results of the processing in the HTML document. Examples of the SSI includes an access counter generally displayed on the homepage, wherein the count of the counter is displayed while updating the count upon each access.

In addition, XML (extensible markup language) is also used on the web of the internet, the XML being a language designed for allowing storage or distribution of information.

In the conventional technique for controlling the web contents, there is a problem in that CGI/SSI is a software or a complete product operating on the web server, and thus an interface for connecting the web contents and other server systems is not provided therein. As a result, CGI/SSI cannot be used for displaying the request of processing exchanged between a web browser and the plurality of server systems.

There is another problem in that since the CGI/SSI can provide a processing or service comparable to the processing or service provided by a server system, the CGI/SSI do not request the other server systems. That is, the process for using the other existing server systems for the sake of CGI/SSI is complicated, wherein the processing by the server system is shifted or transferred to the processing by the CGI/SSI. In this case, even if the CGI/SSI is to be connected to the other existing server systems without using the own processing, the connection is difficult to achieve due to the absence of the interface as recited above.

### SUMMARY OF THE INVENTION

In view of the above, it is an object of the present invention to provide a server system capable of exchanging information between the web browser and a plurality of server systems.

The present invention provides a web server system for use in an internet system including; a web content block including a HTML section and at least one of CG1 and SS1 sections; at least one server processor block for performing a specified processing; and an ID control block for allocating an ID number to each of the web content block and the server processor block, the web content block transferring a message to the server processor block to request a processing of the server processor block based on the ID numbers of the wave content block and the server processor block.

The present invention also provides a method including the steps of: allocating an ID number to each of a web content block and a server processor block; transferring a message for a request of data processing from the web content block to the server processor block based on the ID numbers upon receipt of the request in the web content block from a client computer; transferring a message for a result of processing from the server processor block to the web content block; and transferring the result from the web content block to the client computer.

In accordance with the present invention, the web content block including the CGI/SSI can operate the server processor upon a request of processing from a client, without using a complicated procedure by the web content block.

### BRIEF DESCRIPTION OF THE DRAWINGS

FIG. 1 is block diagram of the system connecting a client computer and a web server according to an embodiment of the present invention.

FIG. 2 is a block diagram of the detail of the web server shown in FIG. 1.

FIG. 3 is a schematic diagram of the data format of transferred document.

FIG. 4 is a flowchart of the operation of the ID control block for register of ID number.

### PREFERRED EMBODIMENTS OF THE INVENTION

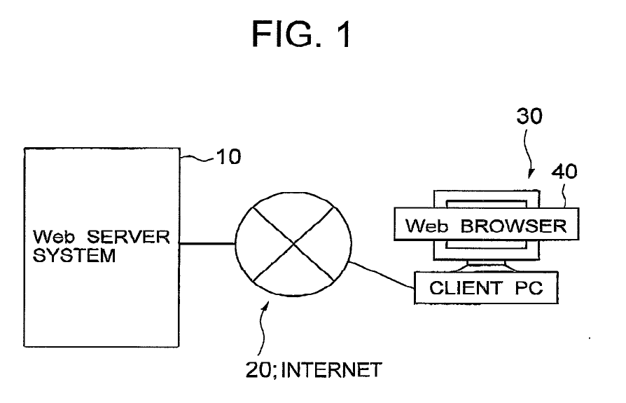

Referring to FIG. 1, a plurality of web server systems (server systems) 10 and a plurality of client computers 30 are connected together through the internet 20, although a single server system 10 and a single client computer 30 are depicted in the figure. The client computer 30 includes therein a web browser 40 for accessing the server system 10 through the internet 20 to display the homepage on the screen.

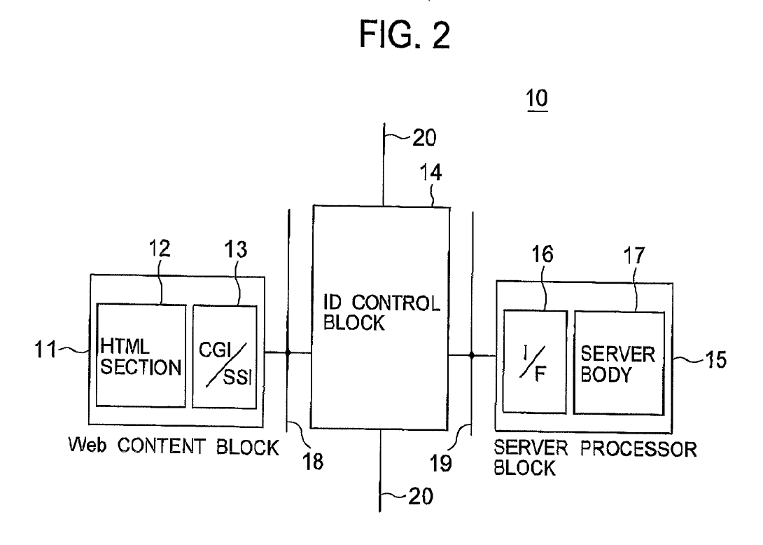

Referring to FIG. 2, each server system 10 includes a web content block 11, a server processor block 15, and an ID control block 14 connected to the internet. The web content block 11 includes therein a HTML section 12 and a CGI/SSI section 13, and is connected to the ID control block 14 through a web interface 18. The server processor block 15 includes a server body 17 and a server interface section 16, and connected to the ID control block 14 through a server interface 19. The ID control block 11 also functions as an interface between the internet 20 and the web server 10

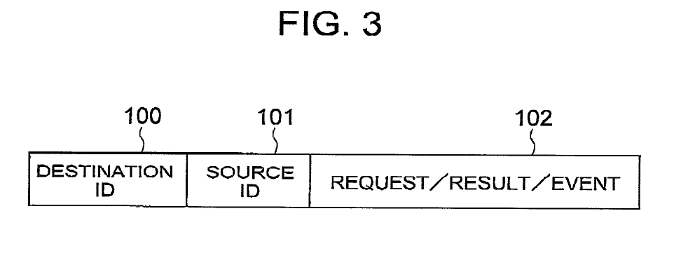

Referring to FIG. 3, the message transferred among the web content block 11, the ID control block 14 and the server processor block 15 in this system includes a destination ID section 100, a source ID section 101 and a message section (data section) 102 having data “request/result/event”, i.e., request for processing, result of processing or event, with a code specifying the type of the data.

Both the web content block 11 and the server processor block 15 have own IDs, which are allocated by the ID control block 14 before connection therebetween for transferring a message. After the disconnection of the web content block 11 and the server processor block 15 from the ID control block 14, the ID control block 14 releases the IDs, whereby data transfer between the web content block 11 and the server processor block 15 cannot be conducted after the disconnection.

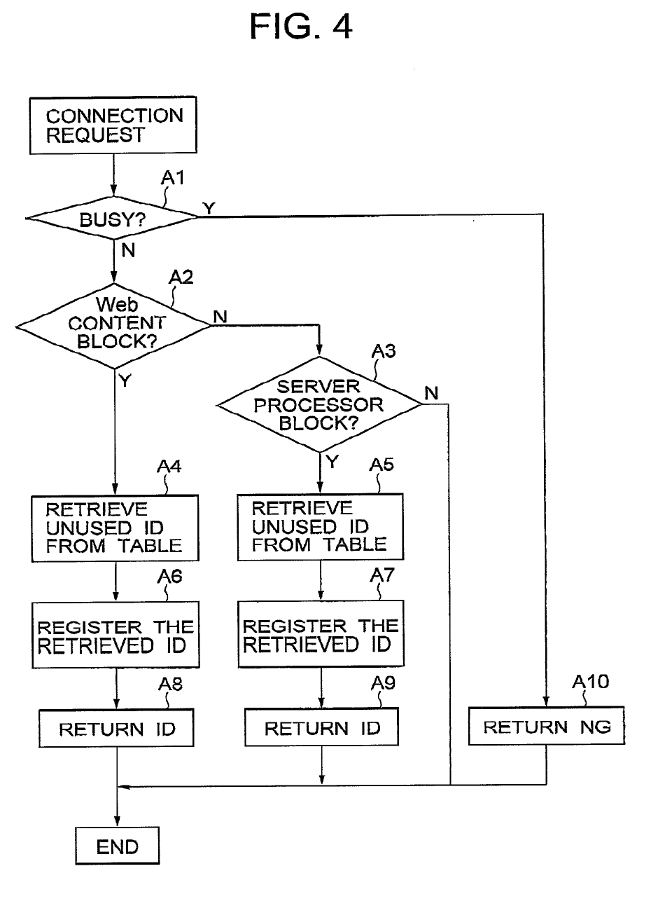

Referring to FIG. 4, a connection request is transferred from the server processor block 15 to the ID control block 14 by transferring the message shown in FIG. 3. The transferred message includes data “000” in the destination ID section, data “000” in the source ID section, and data “001” in the message section.

The codes for the destination ID are determined as follows:

“000” indicates that the destination is the ID control block 14; and “xxx” indicates that the destination is a specified web content block 11 or server processor block 15 which is identified by the ID “xxx” registered in the ID control block 14.

The codes for the source ID are determined as follows:

“000” indicates that the message source is the ID control block 14; and “xxx” indicates that the message source is a specified web content block 11 or a server processor block 15 which is identified by the ID “xxx” registered in the ID control block 14.

The code attached to the data “request” in the message section is as follows:

“001” indicates numbering processing;

“002” indicates inherent data, such as the own name and an available service in the case of server processor block or a data base retrieving server;

“003” indicates health check processing; and

“0004” indicates processing requested from the web content block to the server processor block.

If a plurality of connection requests are delivered from a plurality of server processor blocks at a time, the ID control block 14 selects the connection request based on the first-request-first-accept principle, i.e., accepts a first connection request. The ID control block 14 delivers a return message instructing “delivery of a later request” to each of the second and subsequent connection requests, the requests of which are not accepted. At this stage, the accepted server processor block 15 receives the ID number, whereas each of the other server processor blocks receives “NG”. At this stage, the new ID is not used for the accepted server processor block 15, and the message is transferred based on the IP address and the port number of the server processor block 15.

If the connection request is accepted, the server processor block 15 receives message data including “000” in the destination ID section 100, “000” in the source ID section 101, and “001001” in the message section. The last code is the ID number. On the other hand, if the connection request is not accepted, the server processor block 15 receives message data including “000” in the destination ID section, “000” in the source ID block and “001+NG” in the message section.

Thus, a plurality of server processor blocks are consecutively connected to the ID control block 18, which then prepares receipt of connection requests from the web content blocks 11.

The web content block 11 delivers message shown in FIG. 3 to the ID control block 14 through the web interface 18. The transferred message includes “000” in the destination ID section 100, “000” in the source ID section 101, and “001” in the message section 102, which is similar to that transferred from the server processor block 15. If a plurality of web content blocks 11 request connection to the ID control block, the ID control block accepts the first connection request.

At this stage, the web content block 11 is acknowledged by the ID control block 14 based on the IP address and the port number of the web content block 11.

Referring to FIG. 4, there is shown the operation of the ID control block 14 for connection to the web content block 11 or server processor block 15. When a connection request is delivered to the ID control block 14 and if it is busy for another connection request in step A1, the ID control block 14 returns a message indicating “NG” in step A10, and ends the procedure for the request. On the other hand, if the ID control block 14 is not busy in step A1, the ID control block 14 examines whether or not the connection request is transferred from the web content block 11 in step A2. If the connection request is delivered from the web content block 11, the process advances to step A4, wherein a connection number not used among the usable serial number at this stage is retrieved from a connection table. The connection table lists serial connection numbers or ID numbers starting from 1.

Subsequently, in step A6, the ID control block 14 sets the retrieved number as a used number, and registers the IP number and the port number of the accepted web content block 11 in association with the used ID number. The ID control block 14 then delivers a return mail including the ID number to the accepted web content block 11.

On the other hand, if the connection request is delivered from the server processor block 15, the process advances to step A5, wherein a connection number not used at this stage is retrieved from the connection table

Subsequently, in step A7, the ID control block sets the retrieved number or ID number as a used number, and registers the IP number and the port number of the accepted server processor block in association with the used ID number. The ID control block 14 then delivers a return mail including the ID number to the accepted server processor block 15.

If it is judged in steps A2 and A3 that the connection request is transferred neither from the web content block 11 nor from the server processor block 15, the connection request is not accepted.

By the above process, a plurality of server processor block 15 and a plurality of web content blocks 11 are connected to the ID control block 14.

The web content block 11 retrieves a desired server processor block 15 among the plurality of server processor blocks having ID numbers registered in the ID control block 14.

It is assumed that the web content block 11 is allocated to ID=001, a data base retrieving server (server processor block) is allocated to ID=100, and a statistics data server (server processor block) is allocated to ID=101.

The web content block 11 delivers a request to the ID control block 14 by transferring a message including “000” in the destination ID section, “001” in the source ID section, and “002 and a data base retrieving server” in the message section. This message includes the request that the ID control block 14 provide the ID of the data base retrieving server 15 to the web content block 11. The ID control block 14 then delivers a request to the server processor blocks 15 now connected, by delivering the messages which include a message “100”, “000”, and “002 and a data base retrieving server”, and a message “101”, “000”, and “002 and a data base retrieving server”.

Each server processor block 15 returns a message to the ID control block 14. The data base retrieving server returns a message including “000”, “100” and “002 and OK”, whereas the statistics data server returns a message including “000”, “101” and “002 and NG”. The ID control block 14 receives these messages and then delivers a message based on the received messages to the web content block 11 using the ID number thereof. The message to the web content block 11 in this case includes “001”, “000” and “002100”, the last message indicating the ID number of the retrieved data base retrieving server,

The web content block 11 can obtain the ID number of the statistics data server as well from the ID control block 14. The web content block 11 thus obtains IDs of the server processor blocks 15 of the desired servers, and can deliver a request at any time when necessary.

The web browser (homepage) includes thereon a selection box for specifying a desired item to be retrieved, a retrieving button, a statistic data item, a statistic starting button, and a statistic output display box.

In the example of processing to follow, a person in charge is retrieved from a data base, which includes related information such as the post name, telephone number etc. of persons, and the calling time length of the person in charge is output by the statistics data server, which stores data for calling history, persons called and the frequency of non-response in association with the person in charge, as detailed below.

After the web browser 40 of the client computer 30 accesses a homepage of the web server to read the same, the CGI/SSI are started in the web content block 11 of the web server. The web content block 11 delivers a message to the ID control block 14 for obtaining the own ID “001” and the ID numbers of the server processor blocks, and is connected to the server processor blocks 15.

In the client computer, the web browser displays a selection box for the retrieving item, a retrieving button, a selection box for the statistics data item, a statistics starting button, an output statistics data box. After the client computer selects the person A in the selection box for the retrieving item and click the retrieving button, the web content block 11 responds to the click to retrieve the person A specified in the selection box, and delivers the retrieval request to the server processor block 15 of the data base retrieving server having the ID “100”. The retrieval request includes the message having “100” in the destination ID section, “001” in the source ID section, and “004 and data base retrieval of person A” in the message section.

The message returned from the data base retrieving server includes the message having “001” in the destination box, “100” in the source box, and “004, post name and telephone number” in the message section. After the web content block 11 receives the message from the data base retrieving server, the web content block 11 creates a HTML document including the display content, Thus, the post name and the telephone number are displayed on the screen of the web browser.

After the retrieval of person A is finished, the user on the client computer selects a calling time length in the selection box for the statistics data item, and click the statistics starting button. The web content block 11 responds to the click to read the person A and the calling time length, and delivers a request of statistics data for person A to the statistics data server having the ID “101”. The statistics data request includes the message having “101” in the destination ID section, “001” in the source ID section, and “004, statistics data request of A, and calling time length” in the message section. The returned message includes “001”, “101” and “004 and calling time length”.

The web content block 11 receives the returned message from the statistic data server 15, and creates a HTML document having the display content, whereby the calling time length of the person A in charge is displayed on the screen of the web browser.

In an alternative of the above embodiment, the web content block 11 shown in FIG. 2 may be used as a “remote maintenance”. In this case the web browser displays the state of each server system. After the browser displays the state of each server system, the web server is connected to the server processor block of the server system displayed on the screen. In this case, the web browser displays “server #1, server #2, . . . ” in the selection box or on the selection screen, and “version information, result of health check, interval of health check, log collection, change of setting, . . . ” in the setting box or on the setting screen. By selecting and setting the items, the user selects the server system and the desired processing with specified conditions.

The server system may be of any type so long as the server system can be connected to this system.

The web content block can be used as a “CTI (computer telephony integration) application”. In this case, the server processor block is connected to the CTI server. The web browser displays the telephone directory and a calling button on the screen. The user retrieves and clicks a desired telephone number in the telephone directory, and then clicks the calling button, whereby the client computer dials the desired telephone number. During the call after the dialing, the browser displays “calling” or “busy” on the screen. In this case, the telephone itself may be of any type, such as analog telephone, digital telephone, and IP telephone.

In the above embodiment, a plurality of server processors can be used for a single task for the web content block by transferring requests of processing and the results of processing at a high speed. This is achieved by the configuration that the web content block and the server processor block are connected separately to the ID control block by using separate interfaces.

The function of the ID control block can be installed in the existing interface currently used for the web server. The web content block can be connected to any server processor irrespective of whether or not the server processor is disposed within the own server system. This is achieved by the separate interface for the web content block.

The server processor may be disposed in the web server, or any other server machine which uses TCP/IP protocol.

In the above embodiments the ID number can be canceled by the ID control block. Thus, the web content inquire own ID each time the web content transfers a message. However, if the ID number is not canceled without notification after the allocation thereof, the web content may transfers the message without inquiry of the own ID number.

The specified message described in the embodiment is a mere example, and may be changed as desired.

Since the above embodiments are described only for examples, the present invention is not limited to the above embodiments and various modifications or alterations can be easily made therefrom by those skilled in the art without departing from the scope of the present invention.

What is claimed is:

1. A web server system for use in an internet system comprising: a web content block including a HTML section and at least one of CG1 and SS1 sections; at least one server processor block for performing a specified processing; and an ID control block for allocating an ID number to each of the web content block and the server processor block, the web content block transferring a message to the server processor block to request a processing of the server processor block based on the ID numbers of the wave content block and the server processor block.

2. The web server system as defined in claim 1, wherein the at least one server processor block includes a data base retrieving processor and/or a statistics data processor.

3. The web server system as defined in claim 1, wherein the message includes a destination ID section, a source ID section and a message section.

4. The web server system as defined in claim 3, wherein the message section indicates a request of processing, a result of processing or an event.

5. The web server system as defined in claim 4, wherein the data in the message section is attached with a code.

6. The web server system as defined in claim 1, wherein the web content block delivers the message to the server processor block of another web server system.

7. The web server system as defined in claim 1, wherein the ID control block cancels the ID number after disconnection from said ID control block.

8. A method comprising the steps of:
allocating an ID number to each of a web content block and a server processor block;
transferring a message for a request of data processing from the web content block to the server processor block based on the ID numbers upon receipt of the request in the web content block from a client computer;
transferring a message for a result of processing from the server processor block to the web content block; and
transferring the result from the web content block to the client computer after processing the result in said web content block.

9. The method as defined in claim 8, wherein the web content block has a function of creating a HTML document and CG1 and/or SSI function.
